(19) United States
(12) Patent Application Publication
(10) Pub. No.: US 2024/0267286 A1
(43) Pub. Date: Aug. 8, 2024

(54) PRODUCING DATA ELEMENTS

(71) Applicant: Hewlett-Packard Development Company, L.P., Spring, TX (US)

(72) Inventors: DANIEL ELLAM, BRISTOL (GB); ADRIAN JOHN BALDWIN, BRISTOL (GB); STUART LEES, BRISTOL (GB); NELSON CHANG, PALO ALTO, CA (US)

(73) Assignee: Hewlett-Packard Development Company, L.P., Spring, TX (US)

(21) Appl. No.: 18/564,798

(22) PCT Filed: Jun. 14, 2021
(86) PCT No.: PCT/US2021/037244

§ 371 Date: Nov. 28, 2023

(51) Int. Cl. H04L 41/069; G06F 21/62

(52) U.S. Cl. CPC H04L 41/069; G06F 21/6254

(57) ABSTRACT

In an example, a method is described. The method comprises receiving identifying information associated with an occurrence of an activity within a computing network. The method further comprises receiving an indication of a sequence value generated by a sequence function that iterates the sequence value in response to a metric associated with activity of the computing network triggering iteration of the sequence value. The method further comprises producing a data element representative of the identifying information by using the indicated sequence value as an input to a transformation function for at least partially concealing the identifying information when producing the data element.

### BACKGROUND

Nodes within a computing network may produce logs responsive to events that occur as part of activities within the network. Data analytic techniques may derive information about the computing network from the logs.

### BRIEF DESCRIPTION OF DRAWINGS

Non-limiting examples will now be described with reference to the accompanying drawings, in which:

FIG. 1 is a flowchart of an example method of producing data elements;

FIG. 2 is a schematic drawing of an example system for implementing certain methods, machine-readable media and apparatus described herein;

FIG. 3 is a schematic drawing of an example system for implementing certain methods, machine-readable media and apparatus described herein;

FIG. 4 is a flowchart of an example method of producing data elements;

FIG. 5 is a flowchart of an example method of regenerating data elements;

FIG. 6 is a flowchart of an example method associated with producing data elements;

FIG. 7 is a flowchart of an example method associated with producing data elements;

FIG. 8 is a flowchart of an example method associated with producing data elements;

FIG. 9 is a simplified schematic drawing of an example machine-readable medium associated with producing data elements;

FIG. 10 is a simplified schematic drawing of an example machine-readable medium associated with producing data elements;

FIG. 11 is a simplified schematic drawing of an example apparatus associated with producing data elements;

FIG. 12 is a schematic drawing of an example system for implementing certain methods, machine-readable media and apparatus described herein;

FIG. 13 is a simplified schematic drawing of an example apparatus associated with producing data elements; and

FIG. 14 is a simplified schematic drawing of an example apparatus associated with producing data elements.

### DETAILED DESCRIPTION

A computing network may comprise a plurality of nodes where information may be collected or generated at a node within the network as part of, or in response to, activities that occur within the network. An activity that occurs within the network may be associated with at least one event that occurs as part of the activity. In some examples, a node may produce a log (or a ‘record’) as part of, or in response to, an activity that occurs within the network (e.g., at the node itself or another node within the network). In an example, a log may be produced by a node as part of, or in response to, a single event that occurs as part of a single activity within the network. In another example, multiple logs may be produced by a node as part of, or in response to, corresponding multiple events that occur as part of a single activity within the network. Thus, any reference to an ‘event’ may refer to a node behavior as part of, or in response to, an activity that occurs within the network.

In some examples, the node may collect or generate information based on events that occur on the node itself. In an example, the node comprises a web client to facilitate user interaction with a web-based service. The node may collect information about the user's activity and produce a log comprising the information. In another example, the node comprises an embedded system (e.g., of a printer or Internet of Things (IoT) device) which produces logs in response to execution of code by the embedded system (e.g., due to events that occur on the embedded system).

In some examples, the node may collect or generate information based on events that occur upstream of the node. In an example, the node may receive information from another node (e.g., the web client or embedded system described above) in the network and produce a log based on the received information.

The log may comprise event information comprising information such as an event timestamp, an event identifier for identifying the event type, an identity of the node associated with the event and/or a user identity associated with the event. The log may be stored in a database in the network.

A node may comprise a computing device for implementing certain functionality depending on the setup of the network. A computing device may comprise processing circuitry for executing instructions for implementing the functionality. For example, a computing device may implement functionality such as executing a subroutine as part of an event that occurs on the computing device, producing a log (e.g., in response to executing the subroutine or in response to receiving information from the network indicative of the event occurring on another node of the network), sending a log (e.g., in a telemetry message) to another node in the network for storage or processing, performing data analytics, etc.

A set of logs may be indicative of certain information about the network such as the performance of the network, end-user behavior, suspicious activity, etc.

Data analytics may be implemented to produce alerts, metrics and/or statistics (i.e., ‘output’) based on the set of logs. This output may be reviewed, for example by a human operator or an artificial intelligence-based operator, to determine whether or not the computing network is behaving as expected.

Data analytics may refer to a range of data processing techniques and may include machine learning-based techniques. The data analytics may be of varying complexity and may contain various configurable thresholds and parameter choices to filter and manipulate the input data to produce output. Adjusting these choices may result in different analytic output.

Some analytical tools may filter and/or aggregate the data collected from the network.

Enterprise information technology and security administrators may actively track activity of nodes on their network in an attempt to spot anomalous activity within the network. Raw event data such as logs (e.g., system logs or ‘syslogs’) may be collected from those devices at a networked collector node, for example, a cloud or syslog server. The raw event data may be subject to analysis by various analytical tools.

### Privacy/Confidentiality

When collecting data (e.g., to the cloud) for the purpose of performing data analytics, privacy and confidentiality of the data content may be a concern. For example, regulations may stipulate that collected data be stripped of any information that could be used to identify a device or user that produced the data. Similarly, consumers and organizations may have concerns about sharing any information with a service provider or other entity that is sensitive or could be used to infer information that is not intended to be shared.

Various techniques may be used to transform identifying information into a form that aims to provide at least some degree of privacy to the entity (e.g., a user or the device identity) associated with the identifying information. Such techniques may at least partially conceal identifying information so that the identifying information is either pseudonymized or anonymized.

Anonymization may refer to transforming identifying information associated with a subject so that the subject is not identifiable within a set of subjects from the transformed identifying information.

Pseudonymization may refer to transforming identifying information associated with a subject so that the transformed identifying information is a pseudonym of the identifying information. In other words, the pseudonym does not contain the identifying information itself, but rather another data element that can be linked to the identifying information with certain relevant knowledge but does not directly name the identifying information.

In examples described herein, a ‘data element’ may refer to the result of transforming identifying information so that it is pseudonymized or anonymized. In some examples, a ‘data element’ may be a string of characters representative of identifying information but the string of characters may not explicitly name the identifying information.

In some examples, identifying information can be pseudonymized using tokens that may be mapped to the identifying information in a secure lookup table so that an authorized entity can link a token to the identifying information. An unauthorized entity may find it difficult to work out the identifying information from the token itself without access to the lookup table. However, if the unauthorized entity has access to multiple tokens associated with the same or similar identifying information, it may be possible to extract or infer certain identifying information by analyzing the tokens. Thus, the more tokens that an unauthorized entity has access to, that it knows are associated with certain identifying information, the more likely it is that the unauthorized entity could work out the identifying information.

Other techniques such as encryption, using a key hash function or other cryptographic methods may be used to transform identifying information into a pseudonymized or anonymized data element.

In addition, a combination of techniques such as referred to above may be used to transform identifying information into a pseudonymized or anonymized data element.

Accordingly, ‘identifying information’ such as usernames, hostnames, health status, other personally identifiable information (PII) and sensitive and/or confidential contextual identifying information (such as location and/or role information within an organization such as a corporation, government body or other entity that manages multiple users or devices within a computing network) can be pseudonymized or anonymized by transforming the identifying information into a ‘data element’.

However, data analytics may be used for identifying security concerns, unusual activity and/or monitoring network performance. Data collected for such analytics that at least partially conceals identifying information such as user or device identity or location may be less useful for data analytics. For example, if a security concern is identified by an analytical tool and the collected data does not contain sufficient information to allow identification of the part of the network associated with the security concern, it may be challenging to take action to review and remedy the security concern.

### Producing Data Elements

This disclosure describes a system for refreshing data elements so that, every so often, a transformation function is modified so that transformation of the same identifying information may yield a different ‘data element’ that cannot easily be linked to a previous ‘data element’ produced using the same identifying information. Thus, in some examples, refreshing data elements may reduce the risk of an unauthorized entity being able to link multiple data elements together to extract identifying information.

In some examples, it may be possible for an authorized entity (such as an analytical function that performs data analytics and/or an enterprise function) that does not normally have access to identifying information in the data elements it receives to have implicit or at least partial access to such identifying information (when permitted according to certain enterprise rules e.g., when a security concern is raised). As mentioned above, it may be difficult to link together multiple data elements. However, in some examples, the system may provide a way to link together multiple data elements so that further insights about a computing network can be obtained by the authorized entity.

Certain examples herein describe use of a (e.g., at least one) metric to trigger a refresh as described above. In some examples, the configuration of the trigger may be modified under certain circumstances. In some examples, additional functionality may be provided such as providing at least implicit or partial access to identifying information under certain conditions such as when a security concern is raised.

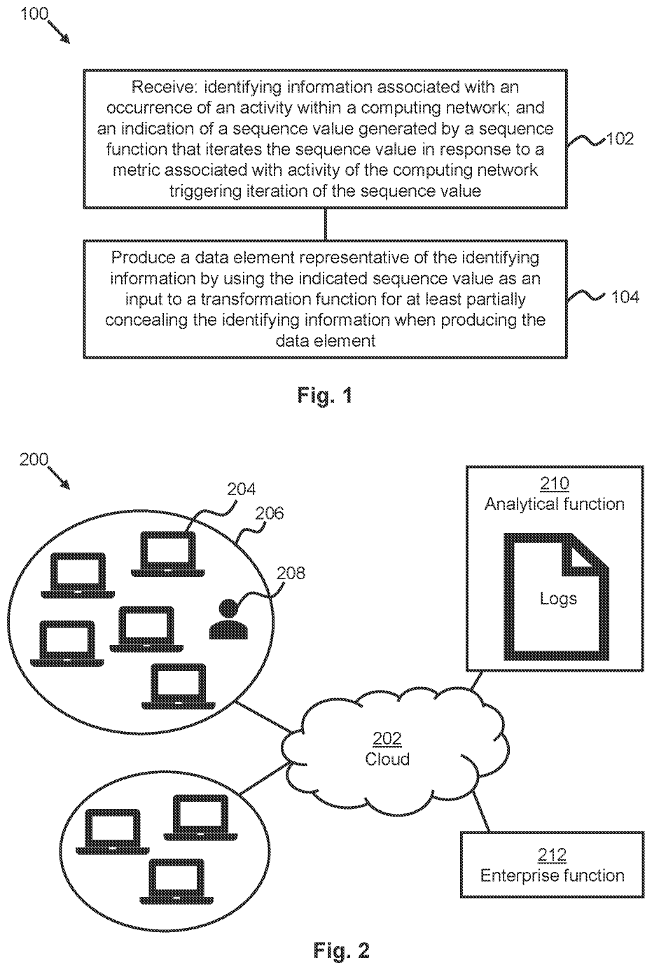

FIG. 1 depicts a flowchart of an example method 100 of producing data elements (e.g., using the ‘metric’ described above). The method 100 may be a computer-implemented method. The method 100 may be implemented by processing circuitry of a computing device.

In one scenario, the method 100 may be implemented by a service provider (e.g., in a server controlled by or accessible to the service provider or in the cloud domain). This scenario may be referred to as a ‘centralized’ scenario.

In another scenario, the method 100 may be implemented by a ‘client’ computing device (e.g., at the ‘edge’ of a computing network) such as an printer, laptop, phone, tablet, ‘smart’ device, Internet of Things (IoT) device or any other computing device that may use a service operated by another entity such as the service provider described above. This other scenario may be referred to as a ‘de-centralized’ scenario.

In the examples described in relation to FIG. 1, reference is made in particular to the ‘centralized’ scenario. However, it is to be appreciated that principles of the examples related to FIG. 1 may be applicable to the ‘de-centralized’ scenario as well.

Accordingly, the method 100 comprises, at block 102, receiving identifying information associated with an occurrence of an activity within a computing network.

An ‘activity within the computing network’ may comprise an event that leads to a log being produced, either by the computing device that performs or registers the event associated with the activity or by another computing device that collects data about such an event. Such a log may comprise ‘identifying information’ about the computing device associated with the event. For example, an event may occur on the computing device as part of the activity and the log may be generated in response to occurrence of the event that is associated with the activity.

Block 102 of the method 100 further comprises receiving an indication of a sequence value generated by a sequence function that iterates the sequence value in response to a metric associated with activity of the computing network triggering iteration of the sequence value.

In some examples, the sequence function may output a sequence value such as a number or character. In some examples, the sequence function may output the sequence value when triggered and store the sequence value until triggered again. In some examples, the sequence function may output the (present) sequence value upon request or each time it is needed.

In some examples, in use, the sequence function is to iterate the sequence value by progressing along a consecutive sequence. For example, a consecutive or linear sequence of sequence values may be generated by the sequence function.

In some examples, such sequence values may not be linearly consecutive. For example, a random sequence value may be generated at each iteration although the sequence may be deterministic if it uses the same starting point. Thus, in some examples, the sequence function is to implement a random sequence value generator to generate an iterated sequence value.

The sequence function may be implemented by processing circuitry (e.g., within the computing network, by a computing device, at a server or in the cloud).

As referred to in block 102, the sequence value may be iterated (e.g., ‘changed’ or ‘modified’) in response to the metric triggering iteration of the sequence value. Thus, the sequence value may remain the same until a trigger causes the sequence function to iterate the sequence value (e.g., change or modify the sequence value).

As also referred to in block 102, activity of the computing network may trigger iteration of the sequence value. This may or may not be the same activity that is associated with the received ‘identifying information’.

In an example, a metric may be derived from or associated with the activity of the computing network that triggers iteration. In an example, the metric comprises a certain number of events that occur within the computing network. In another example, the metric comprises a period of time (e.g., a specified period of time over which the sequence value is to stay the same until an iteration is to be implemented). In another example, the metric comprises a parameter derived from statistical analysis of the activity of the computing network. Any combination of these examples may trigger iteration. Thus, the metric may comprise a parameter derived from operation of the computing network and/or a measure derived from the events that occur within the computing network.

The method 100 further comprises, at block 104, producing (e.g., using processing circuitry of the entity implementing the method 100) a data element representative of the identifying information by using the indicated sequence value as an input to a transformation function for at least partially concealing the identifying information when producing the data element.

The latest sequence value indicated by the sequence function may be used as an input to the transformation function. Thus, the result of the transformation function acting on the identifying information may depend on the input of the sequence value. In other words, if the same sequence value is used as an input (and there are no other changes to the input), the identifying information may be transformed to the same (pseudonymized) data element. However, upon the metric triggering iteration of the sequence value, the identifying information may be transformed to a different (pseudonymized) data element. Thus, a data element ‘refresh’ may occur when a new sequence value is used to produce the data element.

By ‘at least partially concealing’ the identifying information in the produced element, it may not be possible, or at least be difficult, for an unauthorized entity to access or recover the identifying information itself. At least partial concealing may refer to the process of the transformation function transforming the identifying information into the data element (e.g., by a replacement token, a keyed hash function, encryption and/or another cryptographic method).

The transformation function may be implemented by processing circuitry (e.g., within the computing network, by a computing device, at a server or in the cloud). This may or may not be the same processing circuitry that implements the sequence function. Further, the transformation function may or may not be implemented in the same domain as the sequence function. For example, the centralized and de-centralized scenarios described above may provide such functionality within the same or different domains, as explained in more detail below.

In some cases, any two data elements produced based on the same identifying information may be unlinkable, or at least very difficult to link, since the operation of the transformation function may not be reversable and/or the output of the transformation function may be independent of the input to the transformation function. The concept of ‘unlinkability’ may enhance privacy and/or confidentiality since each time the sequence value is changed, an unauthorized entity may find it difficult to build up a picture of the entity or context (e.g., office, location, organization name, etc.) associated with the identifying information if it cannot link multiple data elements together. The more frequently the sequence value is iterated, the more difficult it may be to link together multiple data elements produced over time. However, in some cases, frequent iteration may be inefficient and/or use too many resources. Thus, a balance may need to be reached in terms of how often to refresh (iterate) the sequence value. The re-configurability of the trigger mechanism described herein may provide the ability to refine this balance e.g., depending on network traffic levels, enterprise rules, etc.

The system provided by certain examples described herein (e.g., the method 100 and other examples below) may trigger a ‘refresh’ or ‘rollover’ of (e.g., pseudonymized) data elements in such a way to facilitate management and/or reconfiguration of the trigger function (facilitated by or implemented by the sequence function referred to in the method 100). Thus, the trigger for the iteration of the sequence value may be configurable to provide enhanced control over when and under what circumstances to trigger the iteration. In other words, the way the trigger works may not be fixed. Rather, the trigger can be configured according to a need of an entity such as an analytical function or an enterprise function.

In some examples, the sequence function may receive information (i.e., a ‘metric’) from other functions in the system, such as an analytical function, in order to decide whether to trigger iteration of the sequence value.

Thus, in some examples, the metric is obtained by an analytical function for monitoring the activity of the computing network.

For example, the sequence function may receive data related to activity of the computing network and may be programmed with logic to trigger a new sequence value to be generated (by application of the sequence function to trigger iteration) when a condition is met (e.g., after a certain number of events have occurred or after a certain amount of time has elapsed) unless the logic receives an indication that it is not to allow iteration in spite of the condition being met.

If an analytical function for monitoring security events detects a trend in the computing network which warrants tracking further before linkability is broken by a data element refresh, the sequence function may receive an indication to prevent iteration even if the condition is met.

Thus, in some examples, the trigger may be prevented from causing iteration responsive to the analysis being indicative of suspicious activity of the computing network, even if the condition has been met.

At least one metric may act as a trigger for iterating the sequence value. Examples of metrics may comprise: a specified number of events observed for a given entity (e.g., every 1000 events a refresh is triggered), a specified number of alerts (e.g., security alerts) and/or a specified time period (e.g., every 1 week a refresh is triggered). A combination of metrics may be specified to trigger iteration of the sequence value. For example, the sequence function may trigger iteration if at least one metric is met (e.g., a time-based metric, a number of events occurring, etc.)

The operation of the trigger may depend on how the sequence function reacts to the metric. In some examples, the sequence function may comprise logic to make a decision on whether to trigger iteration of the sequence value based on the metric (e.g., a measurement of a parameter (e.g., time, number of events, etc.) associated with activity of the computing network and/or some other indicator such as whether or not there is a security concern). In some examples, the sequence function logic may receive the decision from another entity (such as an analytical function) on whether to trigger iteration of the sequence value.

Whether or not the metric triggers an iteration may depend on whether the metric crosses a threshold (i.e., a metric crossing the threshold may trigger an iteration of the sequence value). For example, the threshold may be: a minimum specified number of events, a maximum specified number of alerts (i.e., too many alerts within a period of time may be concerning and the system may wish to prevent unlinkability of data elements in this scenario) and/or a minimum specified time period.

In some examples, the management of the trigger may vary for different parts of the system depending on the needs of the client, customer or organization using the system. For example, certain entities may be related, e.g., an individual user may belong to a business unit entity and an office location entity and these groups may be associated with different trigger functionality. For example, the data elements used to pseudonymized identifying information associated with these entities may have their own trigger parameters. In other words, a prioritization may be defined in terms of whether or not to trigger a refresh/iteration of the sequence value depending on the level of privacy to be afforded to the identifying information. For example, data elements produced from personal identifying information may need to be refreshed more regularly (to increase privacy) than data elements produced from other contextual information such as office location or organization name, although other prioritizations may be defined according to need.

In some examples, an entity such as a customer may need to perform forensics to investigate a cyber security incident. Certain systems described herein may allow for decrypting and/or reversing the pseudonymized data elements for a single entity, thereby allowing multiple data elements to be linked, providing the correct authority has been given. The linkage between the multiple data elements may be useful for gaining a better insight into the cyber security incident (e.g., to isolate and/or manage a compromised entity such as an individual computing device or user).

Therefore, certain examples described herein may enable or enhance customer, organizational and/or user privacy whilst still enabling the discovery of data insights. Certain examples described herein may provide the ability to break the tracking of actions over time but in a way that supports the needs of a data analytical function to generate and track action sequences such as those associated with a security incident.

Such enhanced privacy may prevent unauthorized data processors from correlating a given entity over long periods of time which may otherwise raise various concerns such as privacy concerns and/or concerns over leakage of sensitive data such as business information and/or other confidential information. As a result, the system may provide privacy-by-design and/or reduce or minimize leakage of sensitive data while still facilitating certain analysis such as provided by an analytical function.

As an example, if a set of pseudonymized data elements are associated with data indicative of a security concern (e.g., there may be an upward trend in risk as per an (automated) security analysis), then the trigger function may, under these circumstances, not refresh by preventing iteration (even if iteration would otherwise occur). Such a system may allow, under certain (pre-agreed) conditions, such as during a security incident, for trends to be tracked longer and thus discover further data insights in a privacy-by-design system.

By protecting a customer's privacy, such a system may overcome customer and/or regulatory concerns regarding data privacy while allowing provision of a service to extract insights about the pseudonymized data. An improved or more refined trade-off may be reached between maintaining privacy of customer data by reducing the ability to track over time whilst retaining the ability to track where there are complex situations such as security incidents.

FIG. 2 depicts an example system 200 for implementing certain methods, machine-readable media and apparatus described herein. The system 200 may be applicable to both the ‘centralized’ and ‘de-centralized’ scenarios described herein. Thus, the system 200 provides an example architecture for implementing certain methods, machine-readable media and apparatus described herein.

The system 200 comprises the cloud 202 for managing, directing and/or processing data (although a server controlled by an enterprise such as a service provider could perform at least one of these functions). The cloud 202 is communicatively coupled to a set of computing devices (or ‘nodes’) 204. The set of computing devices 204 may form part of at least one ‘computing network’. The set of computing devices 204 may be associated with a context 206 such as office location, organization name, etc. In this example, there are two different contexts 206 depicted, each context 206 comprising several of the set of computing devices 204. Each computing device 204 and each context 206 may be associated with identifying information. For example, each computing device 204 may have its own device identifier (e.g., a device ID) and/or may be associated with a user 208, who may themselves be associated with a user identity (e.g., a name or other PII). When certain events occur within the computing network, logs may be produced, either by the computing devices 204 themselves or at a networked data collector (e.g., in the cloud 202). The log may comprise certain identifying information.

Either within the cloud 202 or on a computing device 204 itself, the identifying information may be transformed into a pseudonymized ‘data element’ at a trusted part of the system 200. However, other information in the log such as ‘event information’ (e.g., an event code associated with the log that is generated in response to the event occurring) may not comprise identifying information but may instead be indicative of activity within the computing network. When producing the logs, the identifying information may be ‘re-written’ as a pseudonymized data element while retaining the event information in its unamended form, or at least still recognizable to an entity that understands the event information or a code representative of the event information.

The logs may be sent to an analytical function 210 for further analysis. The analytical function 210 may extract the event information from the logs it receives but it may not be able to ascertain privacy-sensitive or other sensitive information such as the identifying information. In other words, the analytical function may be able to spot patterns in the received logs but may not be able to identify any entities or contexts.

In case further investigation of a security concern is needed, the analytical function may request permission from an enterprise function 212 (e.g., run by a service provider trusted by the customer or organization) to obtain a certain amount of identifying information and/or attempt to see if there is a link between multiple data elements over a specified time period. In response to this request, the enterprise function 212 may take action to cause regeneration of the data elements of interest and/or release the identifying information to allow further investigation.

The level of identifying information released may depend on the rules set by the enterprise function 212. For example, the enterprise function 212 may cause all the data elements associated with a single item of identifying information or a plurality of items of identifying information to be released (over a requested period of time) in order to allow the analytical function to again receive the data elements in such a way that is isolated from other data elements (e.g., from a different customer, organization or context).

An example scenario may be where there is a large network of nodes comprising multiple contexts 206 (e.g., different offices and/or organizations) and the analytical function 210 receives logs indicating that a certain number of password reset attempts occurred within a specified time frame. In a large network, this may not be especially unusual unless all of those password reset attempts occurred are linked to a certain context 206 (e.g., office location). Thus, the analytical function 210 may wish to investigate further (since it does not presently know which parts of the network the logs came from). The analytical function 210 may contact the enterprise function 212 to seek permission to at least implicitly identify the context 206 (or any other identifying information). The enterprise function 212 may decide whether the analytical function's 210 request meets its rules and then the enterprise function 212 sends a request to the part of the system 200 implementing the method (e.g., in a certain domain of the cloud 202 or on the device 204 itself). In response, as will be explained in more detail below, the system 200 regenerates the data elements associated with the context 206 over a time period of interest (e.g., indicated by the request) and sends these data elements to the analytical function 210. The analytical function 210 compares the data elements to the logs of concern to determine whether there is any pattern of concern. If there is a concern, the analytical function 210 may contact the enterprise function 212 to request that appropriate action be taken (e.g., contact a network admin or other security personnel).

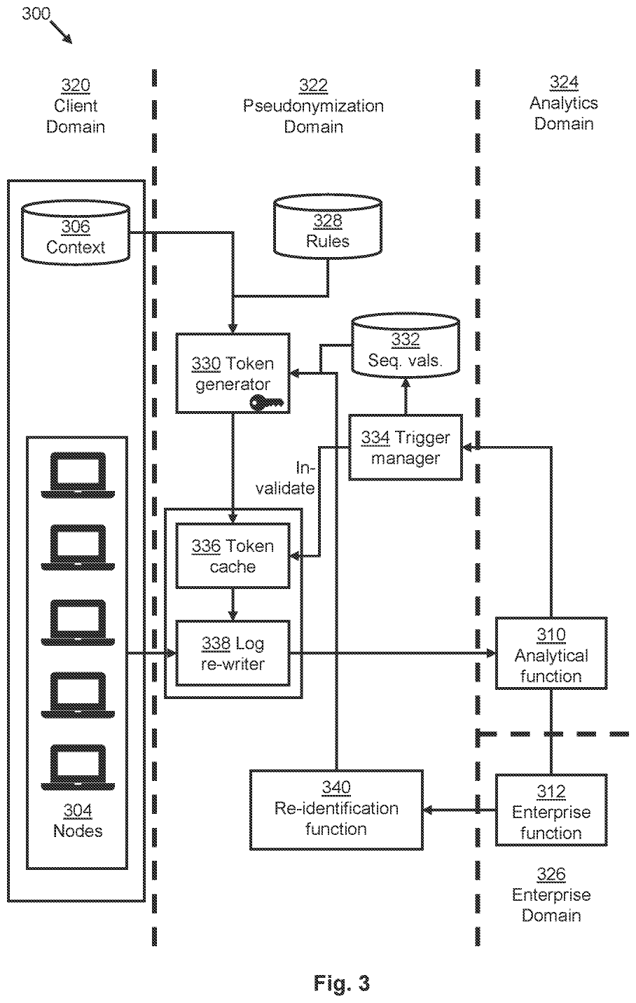

FIG. 3 depicts an example system 300 for implementing certain methods (e.g., the method 100 and related methods), machine-readable media and apparatus described herein. The system 300 is applicable to the ‘centralized’ scenario described herein although certain examples related to the centralized scenario may be implemented by the ‘de-centralized’ scenario described in more detail below. Further, for ease of reference, the ‘data element’ is a token although it is to be appreciated that other types of data elements may be used although the implementation may be different. Reference numbers for like or similar features are incremented by 100 compared with those used in FIG. 2.

The system 300 comprises a client domain 320, a pseudonymization domain 322, an analytics domain 324 and an enterprise domain 326. Each domain may be implemented by processing circuitry either in the cloud or a server managed by an entity such as in the enterprise domain 326. Each domain may have various functions and each function may be implemented by the same or different processing circuitry within the domain. Thus, each domain may comprise at least one module to execute the function (e.g., by storing instructions in a machine-readable medium, the instructions being readable and executable by the processing circuitry of the domain to implement the method concerned). In addition, each domain may comprise storage such as at least one cache for storing any relevant information that may be needed to implement methods described herein.

The client domain 320 may be implemented at the network edge and comprises a set of computing devices, or ‘nodes’, 304. The client domain 320 may store/cache the ‘context’ 306 associated with the set of computing devices 304. The context 306 may comprise identifying information associated with the set of computing devices 304 such as office name, location, organization name, etc. In contrast, the identifying information associated with each computing device 304 may comprise a device identifier and/or a user identifier such as a name.

The pseudonymization domain 322 implements certain methods described herein (e.g., method 100 and related examples). With reference to FIG. 2, the pseudonymization domain 322 may be implemented by processing circuitry in a trusted part of the cloud 202 or by a server (not shown). The pseudonymization domain 322 may be under the control of the enterprise domain 326, or in the cloud 322 with tight control over access and running code.

According to the implementation of the pseudonymization domain 322, certain rules 328 are defined (and stored) for how the transformation function is to operate. These rules 328 may be updated as and when needed. Further details of this example pseudonymization domain 322 are described below.

In this example, a token generator 330 implements the functionality of the transformation function referred to in the method 100 and defined according to the rules 328, although other transformation functions implementing certain cryptographic methods may be used (which may affect the implementation of the pseudonymization domain 322).

Thus, the context 306 (i.e., identifying information associated with the context 306) may be transformed into a data element which, in this example, is in the form of a token. A sequence value 332 (e.g., stored in a cache) used as an input to the token generator 330 may be obtained (e.g., from storage in the pseudonymization domain 322 or may be freshly generated by a trigger manager 334). Although one context 306 is shown in FIG. 3, there may be a plurality of contexts 306, each having its own identifying information.

The trigger manager 334 may at least partially implement the functionality of the sequence function described herein. The trigger manager 334 may make decisions on when and whether to iterate the sequence value 334 based on a metric such as how many events have occurred in the client domain 320 and/or a time period elapsed. The trigger manager 334 may receive input from the analytical function 310, in the analytics domain 324, to cause the trigger manager 334 to decide whether or not to iterate the sequence value 334.

A token cache 336 may store tokens generated by the token generator 330 alongside a one-to-one mapping between the sequence value used as an input to the token generator 330. Depending on the rules 328, the trigger manager 334 may invalidate tokens stored in the cache 336 which are no longer to be used. For example, when a refresh occurs, the tokens stored in the cache 336 may be replaced by tokens produced using the present (up-to-date) sequence value. In some examples, a one-to-one mapping between the produced tokens and the sequence values used to produce these tokens may be stored in the cache 336 or another storage in the pseudonymization domain 322 (e.g., associated with the token generator 330).

A log re-writer 338 has access to the token cache 336 and replaces the identifying information (i.e., ‘transforms’ into ‘data elements’) that would normally represent the context 306 in each log produced as a result of events that occur in the client domain 320. In some examples, PII in individual logs (e.g., from individual computing devices 304) may be pseudonymized and/or anonymized e.g., by tokenization and/or a cryptographic method. Thus, in this example, the log re-writer 338 replaces at least the identifying information associated with the context 306 in any of the logs produced in the client domain 306. The logs retain any event indicators used for future data analysis by the analytical function 310. Thus, the log re-writer 338 may parse incoming events and detect fields for transformation. The log re-rewriter 338 may request the transformation from the token generator 330. This request may go via the local token cache 336 comprising a table of current mappings. The combination of token cache 336 and log re-writer 338 may help with load balancing (e.g., to reduce excess token generation operations by storing tokens for a specified period of time until invalidated).

In some examples, the identifying information associated with individual entities such as PII in the client domain 320 may be transformed instead of, or as well as, the identifying information associated with the context 306.

In this example, the re-written log is then sent by the log re-writer 338 to the analytical function 310.

In some examples, the analytical function 310 may wish to investigate a security concern or unusual behavior in the client domain 320. The analytical function 310 may request that an enterprise function 312 in the enterprise domain 326 requests re-issuance of tokens over a time period of interest. During this time period of interest, multiple sequence values may have been used to break the link between multiple tokens, each associated with the same context 306.

The enterprise function 312 may send a request to a re-identification function 340 in the pseudonymization domain 322 to cause re-issuance of the tokens of interest and/or release of relevant identifying information. The re-identification function 340 may trust the enterprise function 312 and then send a signal to the token generator 330 to cause the token generator 330 to access mapping between the context 306 and the relevant sequence values 332 it used and then regenerate all the tokens associated with at least one item of identifying information such as the context 306. If the client domain 320 comprises multiple contexts 306, the token generator 330 may either generate all the relevant tokens for each context 306 or may select at least one context 306 to regenerate the token(s) for in response to the request from the re-identification function 340. In response, the regenerated token(s) may be sent to the analytical function 310.

If the analytical function 310 knows that the same identifying information was used to generate all the tokens (or at least it can narrow down to a subset of all the contexts 306 used to regenerate the tokens), the analytical function 310 may be able to infer that the same context 306 or subset of contexts 306 is associated with a security concern or unusual behavior. Further action may be taken e.g., by alerting the enterprise function 312 to contact a network administrator or security function associated with the context(s) 306. Similar principles may be applied to other identifying information such as PII associated with individual entities in the client domain 320.

Although reference is made to tokenization in the above example, it is to be appreciated that other transformation functions may be used such as encryption and other cryptographic procedures, as referred to below. Further details of certain systems described herein (including system 200, 300 and other systems described herein, where appropriate) are described below.

### Further Details on Pseudonymization and Contextualization

As noted above, the token generator 330 may produce at least one token (i.e., a type of ‘data element’) by replacing identifying information such as a name (e.g., device ID or user ID) and/or the context 306 with a token. This token may be stored in the cache 336 for use when the log re-writer 338 obtains the token and re-writes at least part of the log to at least partially conceal the identifying information.

An example transformation is as follows. The received log comprises identifying information in the form of <. . . name . . . >, <context1>, <context2>, . . . , <context_n>(in some examples, there may be at least one item of context in addition to the name, if present).

This identifying information is replaced by the transformation function with a token (represented by the letter, ‘t’ with the associated input identifying information in parentheses) for each item of the identifying information to produce the following log: <. . . t(name), t(context1), . . . ,t(context_n) . . . >.

The log may further comprise an event identifier comprising information about an event associated with the name and/or context. The event identifier may not be transformed e.g., to allow the analytical function 310 to perform its function.

In some examples, the contextual information about a name token may, when made available, be used by the analytical function 310 to help identifying attacks against people within a given context or a given context e.g., where devices associated with those people are not managed as expected or are malfunctioning.

In this example, the tokens are pseudonymized tokens so that an observer is unlikely to be able to map from ‘t(name)’ back to ‘name’. To prevent unauthorized reversal of a token, care may need to be taken to use relevant identifying information sparingly.

In some examples, the name token may be encrypted e.g., using a key stored in the pseudonymization domain (with a suitable encryption mode such that the encrypted token is different each time). Encryption of the name token may allow for controlled reidentification but not analytics based on an individual user.

### Time-based Token Refresh

To enhance privacy and/or confidentiality, the sequence values may be iterated after a specified period of time to refresh the tokens (e.g., to reduce ‘linkability’ or ‘traceability’).

Traceability may be adversely affected by the token refresh since it may be more difficult to map from ‘t(name)’ back to ‘name’ (where ‘t’ represents the token of the name entity) and then to other tokens to look for previous suspicious events. However, traceability may be enabled under controlled circumstances to facilitate such traceability.

In an example, a mapping comprising identifying information and a corresponding token and/or sequence value may be cached. This mapping may be used to look up the identifying information and sequence value to allow regeneration of the corresponding token using the token generator 330 if the token is not already available. Upon having access to the identifying information, multiple tokens may be generated for each associated sequence value so that it is possible to determine which identifying information is associated with which tokens.

In another example, traceability may be facilitated by re-generating sequences or tokens by using at least one of: a key, identifying information and/or at least one of a set of sequence values where various approaches may be taken to re-generate at least one token for traceability purposes. Traceability may be facilitated with the key if a message authentication code (MAC) based token is used or by creating (reversable) name tokens (using symmetric encryption) instead of anonymized name tokens. In an example, a systematic approach may be used where each token is generated for each combination of identifying information and sequence value(s). Another approach may involve trial and error (e.g., until a matching token is found). In another example, encryption may be used e.g., using the function Sym_Encrypt(key, Name∥Time∥Pad) where time is expressed in terms of the frequency of the counter (sequence value) change and the key can be used to decrypt the data element when needed.

### Triggering Token Refresh

As described above, a metric may trigger a token refresh so that there is no easily derivable link between adjacent tokens. There may be various ways of managing the trigger in order to accommodate unlinkability but with the option to re-create linkability when certain conditions are met. The token refresh may occur after a specified period of time (e.g., every week or another appropriate period of time) and/or after a certain number of events have occurred and such metrics may cause the token refresh.

In some examples, the sequence function generates a sequence(k) which iterates a value in response to a trigger such as the metric meeting a condition.

The sequence function may have multiple inputs (e.g., user-driven inputs, event numbers, time, suspicious event counts, etc., which may be referred to as <input values>). In this example, the sequence function comprises a trigger function as follows: triggerFunct_i(<input values>)→SequenceIncrement_i,t for sequence_i. The i-th sequence refers to the i-th context (or other identifying information) so that each context(i) may have its own sequence of sequence values although in other examples the same sequence of sequence values may be used for each context. The triggerFunct_i yields the sequence value, seqVal_i,t as the value for the sequence_i at time t.

The trigger function may be executed when input changes (or at a defined regular times (e.g., hourly, daily, weekly, etc.) based on a link to an analytical function 310) and under normal circumstances the sequence increment may be 0 (i.e. it does not iterate). But if some trigger happens then the sequence increment may be positive (and potentially random, which may make the sequence increment non-deterministic). The use of a random rather than fixed or linear increment may affect the controlled reversibility properties so that additional information (e.g., information about a random seed used for the sequence function and/or information about the sequence itself, etc.) may need to be cached in order to retrieve the identifying information when needed.

Examples of input to the trigger function may comprise iterating after ‘x’ number of events but don't iterate if there are >y suspicious events. Holding the sequence value (to remain the same as long as needed) may help to detect unusual behavior or security concerns. However, in some examples, a maximum time or number of events may be specified after which a refresh is to occur irrespective of the sequence hold.

In some examples, a mapping between an entity in the client domain 320 and a sequence may be generated in order to provide distinct sequences for each name and/or context.

For example, the sequences themselves can be associated with multiple entities that may be mentioned in events. Thus, entity names may be linked to a sequence (e.g., a ‘name indicator’ may indicate which entity name is associated with a specified sequence, which may be unique or otherwise associated with the name). Thus, a mapping function may map a name and/or context (or any other identifying information) to a given sequence which is to be used by the token generator for each item of identifying information associated with the given sequence.

By way of example, a user may have their own sequence and a context such as a geographic location (e.g., a city in a country or the country, depending on granularity) may have its own sequence.

A binding may be defined by policies using contextual information. For example, a name may be associated with at least one context (e.g., organization, office, role, etc.) A specified sequence may be associated with the name (i.e., ‘sequence_name’ or ‘SeqName’). In addition, the organizational (org) context may map to a sequence_org and the office may map to a sequence_office, where ‘org’ and ‘office’ represent the organization a given user works in and office is the office location where the user is based. If a user has a role in admin_role_list then ‘sequence_admin’ may be used or if their role is in managerList then ‘sequence_manager’ etc. The sequences associated with each respective name and context may therefore be used to distinguish between different contexts, as needed.

The sequence naming strategy may be such that it is easy to find the correct sequence for a given name. Thus, a mapping from the name and context to ‘SeqName’, which is the name of a sequence managed within the token generator, may be cached. In an example, a sequence may be named as hash(seqName) where the seqName is defined in the rules above. Then, a sequence name may be a hash value.

One concern relates to the possibility of an adversary observing sequence value changes and correlating such changes with token changes. Hence, countermeasures may be deployed. In an example, sequence names could be transformed by a function such as a hash-based message authentication code function, i.e., hmac(key,seqName) rather than a hash so, without the key, the sequence name may not be obtained. In another example, sequence values may not be made public outside of the token generation system. In a distributed/de-centralized architecture, this may mean a secure channel is needed for key distribution. In another example, sequences may be grouped such that no individual sequence name has a one to one mapping with a sequence.

An example procedure for token generation using a sequence is now described.

In an example, a token for a name or context is generated as a function of: a key, the current value from at least one sequence, and the name that the token represents. For example, such a token could be obtained from a key derivation function, KDF: (key, <seqVal(SeqName)>∥name/context) where name/context is either the name directly or a context (e.g., obtained by looking up the name).

In another example, an encrypted token could be used instead to provide reversibility for the key holder. For example, the encrypted token may be generated by a symmetrical function, Sym, acting on the name or context: Sym(key,<seqVal(name)>∥name).

The encryption mode may be such that a token or set of tokens can be generated or re-generated in a repeatable manner when needed (e.g., to facilitate traceability) although the tokens associated with a certain item of identifying information may not necessarily be correlated with each other easily due to the token being refreshed every so often, as described herein. An example encryption mode may be an electronic codebook (ECB) mode, which may provide a searchable output of tokens which cannot be easily correlated with each other to reduce the risk of concerns over releasing private or sensitive data. The ECB mode may use a key (e.g., a new key) to facilitate access to a token generated by the mode. Other example modes which may facilitate access to or re-generation of at least one token when needed may include: counter (CTR) mode, cipher block chaining (CBC), Galois/Counter Mode (GCM). However, in any such modes, the counter, initialization vector (IV), etc., may be fixed or incremented in a recordable/repeatable manner to facilitate token re-generation (i.e., in a repeatable manner so that traceability may be enabled). In any of these modes, for an item of identifying information and a fixed key, the output ciphertext is repeatable providing the input values (e.g., counter values, IVs, etc.) to the transformation function are accessible or can be re-generated.

As already noted, data elements may be pseudonymized or anonymized. In an example, a name of an entity may be anonymized while the context may be pseudonymized. For example, every time an entity is observed in a log, its name may be encrypted with the token generator key with a fresh initialization vector (IV) or random padding so the token is unique for each use. Meanwhile associated contextual information such as office location may use the token sequence generator to pseudonymized the context.

A description of the link between the analytical function 310 and the trigger function (e.g., of the trigger manager 334) is now given. The trigger function logic may use counts, timers, and other statistics to decide on when to trigger a token refresh. These statistics may be based on data generated by entities that are themselves pseudonymized. In an example, a trigger rule may specify that tokens for users associated with a certain office context get refreshed (i.e., iterated) every 100 events from that given office.

In an example, the trigger function may subscribe/register to the analytical function 310 to obtain the metric and may perform any of the following examples:

In an example, the trigger function may obtain event counts for certain entities (e.g., an entity named user1@companywide.com) but as the associated token is pseudonymized, the trigger function may need to register for the current token and then reregister for new tokens as they are generated by the token generator 330.

In another example, the trigger function may register for the output of certain analytics (e.g., event counts or alert counts) along with the associated tokens. This way, as new information is received by the trigger function, the trigger function may use (or calculate and use) any new statistics and iterate the sequence value according to the rules.

In another example, the trigger function may place a lower bound on the amount of time between token refreshes. For example, the token for the username ‘user1@companywide.com’ may currently be ‘abcd123’, which may be refreshed after 50 observations of the same token, as long as at least 1 hour has elapsed between the first and most recent observation. The trigger function may then observe aggregated statistics from the analytical function 310 (e.g., hourly) and use these statistics to check which tokens are to be refreshed. This example may reduce overheads on the system by a specifying a minimum time period before causing a refresh.

Accordingly, the choice of how to manage and/or modify the trigger function, and how the trigger function uses the metrics, may depend on the implementation of the analytical function 310 and the architecture of the system 300 itself.

### Forensics

In an example, if an admin in the client domain 320 behaves strangely, then it may be possible to use certain systems described herein to look back to previous tokens and see what else may have happened with the same. Some tokenization designs may not allow analysis across a token refresh period.

However, the situation is different for certain systems described herein. In the centralized architecture, there may be a centralized token generator which uses the name as part of the generator system. If the name and sequence values are available, then using the secret key, it may be possible to generate a set of tokens that would be generated over time and search for them (e.g., within a database of tokens recorded by the analytical function 310).

When an issue is noticed with a certain token (or a set of tokens), reversal may be achieved if a list of recent token to user mappings is maintained (in the pseudonymization domain 322) or if the system 300 implements reversable tokens using an encryption/decryption mechanism with a key stored in the pseudonymization domain 322.

In some examples, it may be sufficient to have a mapping from name tokens (as long as they are in the messages) associated with a context, as this may allow mapping back to the context (e.g., if permission is granted by the enterprise function 312).

### Sequence Value Leases

Changes to sequence values may complicate the cache management and potentially lead to messaging between load balanced components. In examples where a token generation function is implemented in a distributed/de-centralized architecture, sequence value changes may lead to excessive messaging between entities. Thus, a sequence lease time may be specified where the system 300 is prevented from allowing a sequence iteration for a minimum specified time period (i.e., a ‘lease’). The lease may therefore gate output from the trigger function such that the sequence value iterations are permitted after expiry of the lease. In some examples, the timescale of the lease may be minutes or hours, depending on the level of messaging that occurs for a given network size.

### Further Implementations of Certain Systems

The following examples refer to various methods that may be performed by certain systems described herein (e.g., the system 300 and any other appropriate systems). Reference is made to the systems 200, 300 described above.

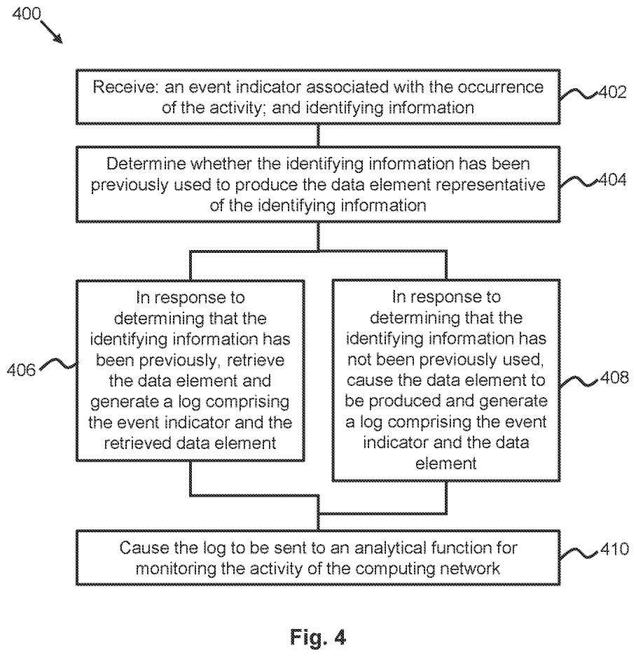

FIG. 4 depicts a flowchart of an example method 400 of producing data elements (e.g., using the ‘metric’ described above). The method 400 may be a computer-implemented method. The method 400 may be implemented by processing circuitry of a computing device (e.g., in the pseudonymized domain 322). The method 400 may comprise or make reference to certain blocks of the method 100 and related examples and therefore reference is made to FIGS. 1 to 3 as well.

The method 400 comprises, at block 402, receiving an event indicator associated with the occurrence of the activity. Block 402 further comprises receiving the identifying information (as referred to in the method 100).

The method 400 further comprises, at block 404, determining whether the identifying information has been previously used to produce the data element representative of the identifying information. For example, the cache 336 of FIG. 3 may store previously produced data elements.

In response to determining that the identifying information has been previously used to produce the data element, the method 400 comprises, at block 406, retrieving, from storage (e.g., the cache 336), the data element representative of the identifying information and generating a log (e.g., by the log re-writer 338) comprising the event indicator and the retrieved data element.

in response to determining that the identifying information has not been previously used to produce the data element, the method 400 further comprises, at block 408: causing the processing circuitry to produce the data element representative of the identifying information; generating a log comprising the event indicator and the data element.

The method 400 further comprises, at block 410, causing the log to be sent to an analytical function for monitoring the activity of the computing network (e.g., as shown by the link between the log re-writer 338 and the analytical function 310 in FIG. 3).

Thus, the method 400 may refer to the operation of token generation and log re-writing as described in relation to FIG. 3.

FIG. 5 depicts a flowchart of an example method 500 of regenerating data elements. The method 500 may be a computer-implemented method. The method 500 may be implemented by processing circuitry of a computing device (e.g., in the pseudonymized domain 322). The method 500 may comprise or make reference to certain blocks of the method 100 and related examples and therefore reference is made to FIGS. 1 to 3 as well.

The method 500 comprises, at block 502, receiving a request to produce a set of data elements. The request may be indicative of a time period of interest during which at least one sequence value was used as the input to the transformation function.

In response to receiving the request, the method 500 comprises, at block 504, obtaining identifying information and/or the at least one sequence value used in the time period of interest. For example, the mapping may be accessed to trace back to the identifying information and/or or the data element may be decrypted.

The method 500 comprises, at block 506, producing the set of data elements for each combination of the obtained identifying information and the obtained at least one sequence value.

The method 500 comprises, at block 508, causing the produced set of data elements to be sent to an analytical function for monitoring activity of the computing network.

Thus, the method 500 may refer to the re-identification of the identifying information described above.

In some examples, the analytical function 310 may use the produced set of data elements to analyze historical activity of the computing network (e.g., within the client domain 320) associated with the identifying information.

In some examples, where a mapping between the identifying information and at least one sequence value used to generate corresponding data elements representative of the identifying information is available, the identifying information and the at least one sequence value may be obtained by retrieving the identifying information and the at least one sequence value mapped to the identifying information.

In some examples, where the data element is produced by encrypting the identifying information; and where the request comprises the data element and an authorization to decrypt and/or a key for decrypting the data element, the identifying information may be retrieved by decrypting the data element.

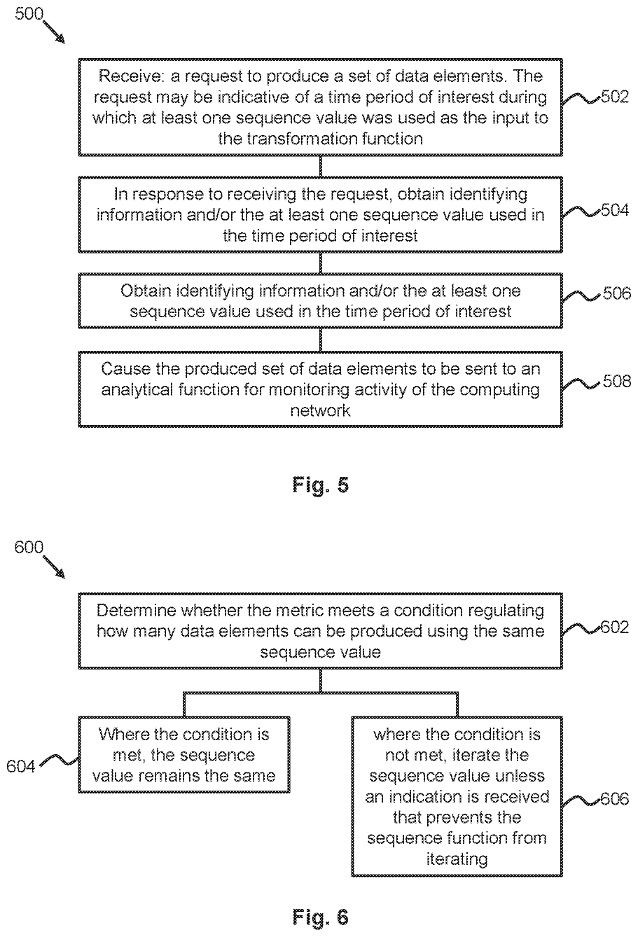

FIG. 6 depicts a flowchart of an example method 600 associated with producing data elements. The method 600 may be a computer-implemented method. The method 600 may be implemented by processing circuitry of a computing device (e.g., in the pseudonymized domain 322). The method 600 may comprise or make reference to certain blocks of the method 100 and related examples and therefore reference is made to FIGS. 1 to 3 as well.

The method 600 comprises, at block 602, determining whether the metric meets a condition regulating how many data elements can be produced using the same sequence value.

According to block 604 of the method 600, where the condition is met, the sequence value remains the same

According to block 606 of the method 600, where the condition is not met, the sequence function iterates the sequence value unless an indication is received that prevents the sequence function from iterating the sequence value.

Thus, the method 600 may refer to the functionality of the sequence function described above.

In some examples, the condition comprises a specified number of events occurring within the computing network. In some examples, the condition comprises a specified time frame.

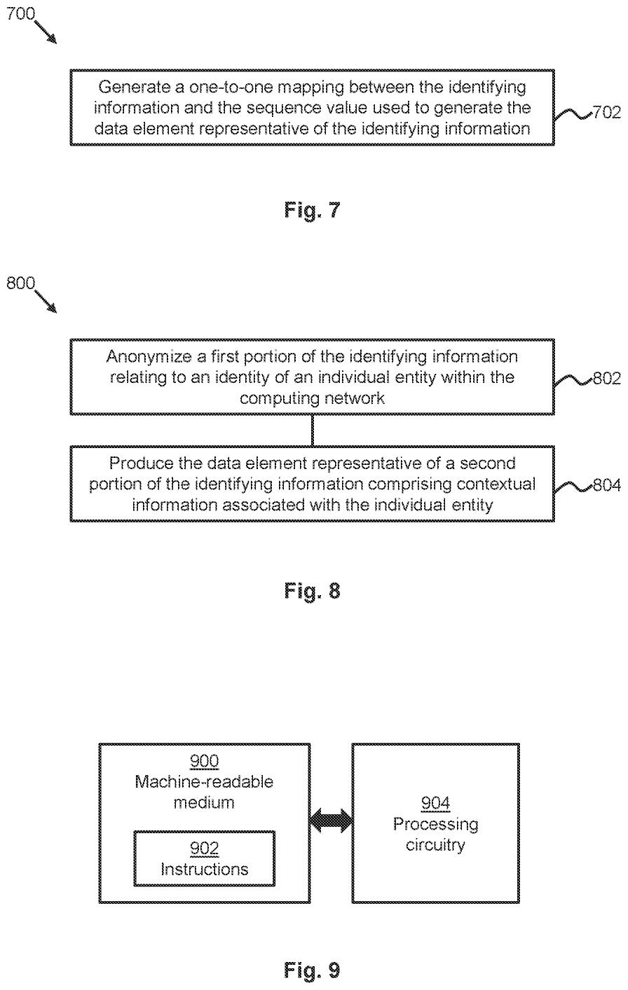

FIG. 7 depicts a flowchart of an example method 700 associated with producing data elements. The method 700 may be a computer-implemented method. The method 700 may be implemented by processing circuitry of a computing device (e.g., in the pseudonymized domain 322). The method 700 may comprise or make reference to certain blocks of the method 100 and related examples and therefore reference is made to FIGS. 1 to 3 as well.

The method 700 comprises, at block 702, generating a one-to-one mapping between the identifying information and the sequence value used to generate the data element representative of the identifying information.

Thus, method 700 may refer to caching the mapping as described above, e.g., to allow for extracting and/or regenerating identifying information.

In some examples, contextual information (e.g., context 306) associated with the identifying information is used by the sequence function to produce a specified sequence of sequence values for use in producing data elements representative of identifying information associated with the contextual information. In some examples, the generated mapping comprises a name indicator (as described above) of the specified sequence.

FIG. 8 depicts a flowchart of an example method 800 associated with producing data elements. The method 800 may be a computer-implemented method. The method 800 may be implemented by processing circuitry of a computing device (e.g., in the pseudonymized domain 322). The method 800 may comprise or make reference to certain blocks of the method 100 and related examples and therefore reference is made to FIGS. 1 to 3 as well.

The method 800 comprises, at block 802, anonymizing a first portion of the identifying information relating to an identity of an individual entity within the computing network.

The method 800 further comprises, at block 804, producing the data element representative of a second portion of the identifying information comprising contextual information associated with the individual entity.

Thus, the method 800 may refer to the scenario where an entity identifying information is anonymized and a context identifying information is pseudonymized, as also described above.

FIG. 9 schematically illustrates an example machine-readable medium 900 (e.g., a tangible machine-readable medium) which stores instructions 902 which, when executed by processing circuitry 904 (e.g., at least one processor), cause the processing circuitry 902 to carry out certain methods described herein (e.g., method 100, 400, 500, 600, 700, 800 and/or implement other examples relating to the systems 200, 300). In some examples, the machine-readable medium 900 may implement certain functionality within the pseudonymization domain 322 of FIG. 3. In some examples, the machine-readable medium may implement at least some of the functionality described in relation to the de-centralized scenario, described in more detail below.

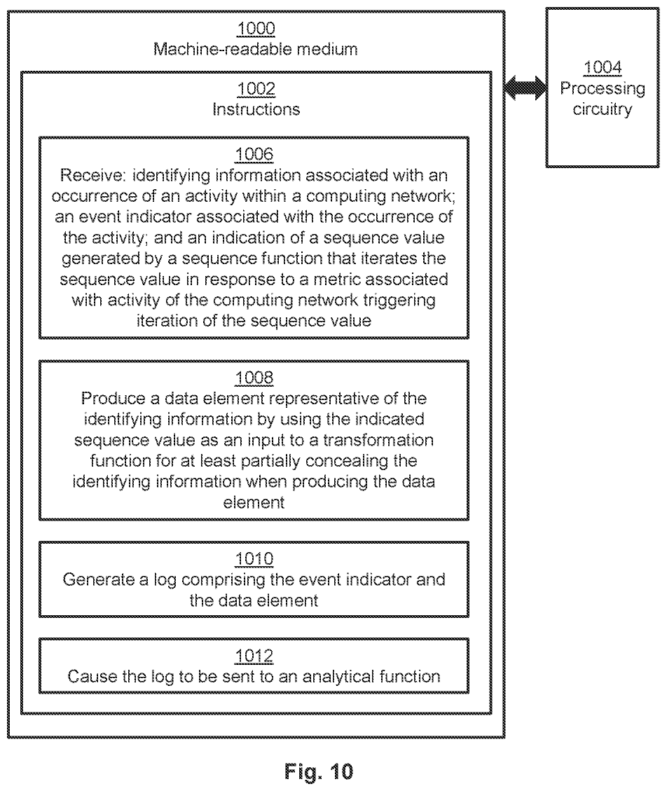

FIG. 10 schematically illustrates an example machine-readable medium 1000 (e.g., a tangible machine-readable medium) which stores instructions 1002 which, when executed by processing circuitry 1004 (e.g., at least one processor), cause the processing circuitry 1002 to implement a combination of methods described in relation to FIG. 1. In some examples, the machine-readable medium 1000 may implement certain functionality within the pseudonymization domain 322 of FIG. 3. The method 1000 may refer to a combination of features described in relation to the examples associated with the method 100.

In this example, the instructions 1002 comprise instructions 1006 which cause the processing circuitry 1004 to receive identifying information associated with an occurrence of an activity within a computing network. The instructions 1006 further cause the processing circuitry 1004 to receive an event indicator associated with the occurrence of the activity. The instructions 1006 further cause the processing circuitry 1004 to receive an indication of a sequence value generated by a sequence function that iterates the sequence value in response to a metric associated with activity of the computing network triggering iteration of the sequence value, where the metric is obtained by an analytical function for monitoring the activity of the computing network.

The instructions 1002 further comprise instructions 1008 to produce a data element representative of the identifying information by using the indicated sequence value as an input to a transformation function for at least partially concealing the identifying information when producing the data element.

The instructions 1002 further comprise instructions 1010 to generate a log comprising the event indicator and the data element.

The instructions 1002 further comprise instructions 1012 to cause the log to be sent to the analytical function.

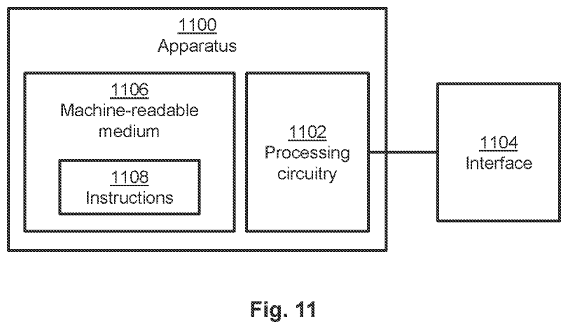

FIG. 11 is a schematic illustration of an example apparatus 1100 for implementing or at least partially facilitating certain methods or machine-readable media described herein (e.g., certain blocks of methods 100, 400, 500, 600, 700, 800, certain instructions of machine-readable media 800, 900 and/or certain features of systems 200, 300). The apparatus 1100 comprises processing circuitry 1102 communicatively coupled to an interface 1104 (e.g., implemented by a communication interface) for: receiving information such as identifying information and/or sequence values, receiving logs to be re-written and/or communicating with other entities e.g., in other domains.

In an example, the interface 1104 may receive information, via the interface 1104, from another node such as in the pseudonymization domain 322, client domain 320 and/or analytics domain 324, which information is used by the apparatus 1100 when implementing certain methods or machine-readable media described herein. The apparatus 1100 further comprises a tangible machine-readable medium 1106 (e.g., ‘memory’) storing instructions 1108 readable and executable by the processing circuitry 1102 to perform a method according to various examples described herein (e.g., certain blocks of method methods 100, 400, 500, 600, 700, 800) or implement the functionality of machine-readable media instructions according to various examples described herein (e.g., certain instructions of machine-readable media 800, 900).

### De-Centralized Scenario

The following description refers to the de-centralized scenario referred to above. The de-centralized scenario may use the same or a similar concept as described in relation FIG. 1 and other examples described herein but the implementation may be different, as described below.

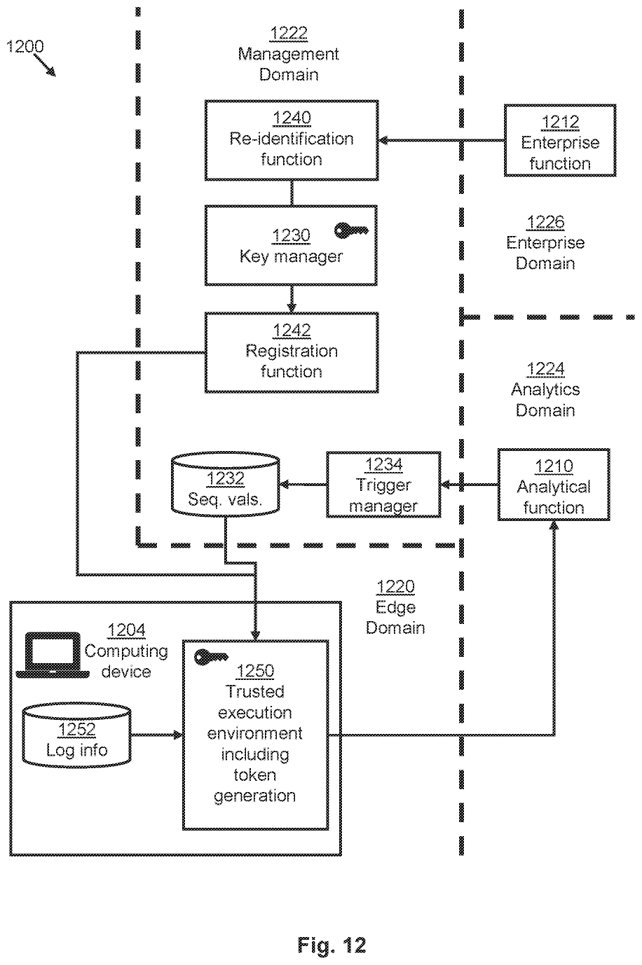

FIG. 12 depicts an example system 1200 for implementing certain methods, machine-readable media and apparatus described herein. The system 1200 is applicable to the ‘de-centralized’ scenario described herein although certain examples related to the de-centralized scenario may be implemented by the ‘centralized’ scenario described above. Further, for ease of reference, the ‘data element’ is a token although it is to be appreciated that other types of data elements may be used although the implementation may be different. Reference numbers for like or similar features are incremented by 900 compared with those used in FIG. 3, with which the system 1200 may share some functionality.

The system 1200 comprises an edge domain 1220 (to reflect the computing device 1204 is an edge device although this may be similar to the client domain 320 of FIG. 3), a management domain 1222 (which may include certain similar functionality to at least part of the pseudonymization domain 322 of FIG. 3), an analytics domain 1224 and an enterprise domain 1226.

In contrast to the system 300 of FIG. 3, the anonymization/pseudonymization occurs in the computing device 1204, at the edge, rather than in the management domain 1222. Thus, each computing device 1204 in the computing network may produce its own data elements.

The operation of the trigger manager 1234 may be similar to that described in relation to FIG. 3. However, instead the sequence vales 1232 may be sent via a channel to the computing device 1204.

In further contrast to the system 300 of FIG. 3, the management domain 1222 comprises a key manager 1230 which may form, via a registration function 1242, a secure channel with the computing device 1204. The secure channel may be used to communicate keys managed by the key manager 1230.

In addition, the management domain 1222 comprises a re-identification function 1240 communicatively coupled to the enterprise function 1226, which itself may be communicatively coupled to the analytical function 1210.

Accordingly, in use, the computing device 1204 may receive a key and a sequence value 1232 from the management domain 1222. The management of the trigger may vary to the centralized case to avoid excessive messaging between domains.

The computing device 1204 comprises a trusted execution environment 1250 (e.g., implemented by processing circuitry in a secure area of the computing device 1204) for producing the logs comprising pseudonymized/anonymized data elements. The computing device 1204 may generate or collect logs (e.g., in log info store/cache 1252) comprising ‘event information’ such as an event indicator. Thus, by using the event information along with the name and/or context of the computing device 1204, the log may be transformed into a log comprising the data element to at least partially conceal the identifying information.

Accordingly, the system 1200 may operate in a similar way to certain parts of the system 300 but the production of the data elements occurs at the edge and at least one channel may need to be set up between the edge domain 1220 and the management domain 1222 to facilitate exchange of information for producing the logs.

Further details of the system 1200 are given below.

It may be useful to have the ability to move from token generation in a centralized scenario to tokenization that happens on each device, i.e., in a de-centralized scenario. This ability may provide more controlled privacy/confidentiality and control as the related functionality of the pseudonymization domain (as implemented in this example by the management domain 1222 in combination with the edge domain 1220) may be simplified compared with previous examples relating to the pseudonymization domain 322.

In an example, the trusted execution environment (TEE) 1250 may be implemented on each device 1204 (e.g., using TrustZone) where secure operations can be performed and keys stored.

As part of the set-up procedure, a secure enrolment process (by the registration function 1242) may be used to provide a secure channel between the key manager 1230 and a token generator function and tokenization service implemented in the TEE 1250. The registration function 1242 may define or set-up at least one of the following: Token rewrite rules, name or context to sequence identity (‘sequence_i’) mapping rules and/or set up a sequence secure channel.

A logging system implemented by the computing device 1204 may send at least part of a log to the TEE 1250 (along with context information such as an associated active directory record). The tokenization service implemented by the TEE 1250 may then generate the associated token(s). As part of this implementation, the TEE 1250 may check that context data is present. For the name and each item of context, the associated sequence names may be derived (both from the mapping rules and then any transformation needed). A local sequence value cache (e.g., stored in the TEE 1250 or accessible in the storage/cache of sequence value(s) 1232 in the management domain 1222) may be checked to check for any iterations in the sequence value. Lease values, as described above, for the sequence values may be assessed. If the lease is valid, the sequence value may be used and may not be iterated until the lease expires, in which case, the TEE 1250 accesses the management domain 1222 with a request (using a secure channel) to get the latest sequence value(s).

The tokens may then be generated as in the centralized case and returned (e.g., to the analytical function 1210).

In an example, a cache of tokens with times linked to sequence leases may also be used to save recalculating context rules. Further, saving sequence names etc., may be used to ensure efficiency.

The distributed/de-centralized approach may need the sequence value leases to be efficient to stop requests going back to the management domain 1222 each time a data element is to be generated.

The forensics functionality mentioned above may be more complex than for the centralized scenario since each device 1204 may not be relied on to cache the mappings. Accordingly, any identifying information that needs to be traced may be encrypted so that when traceability is needed, decryption can be used to retrieve the identifying information.

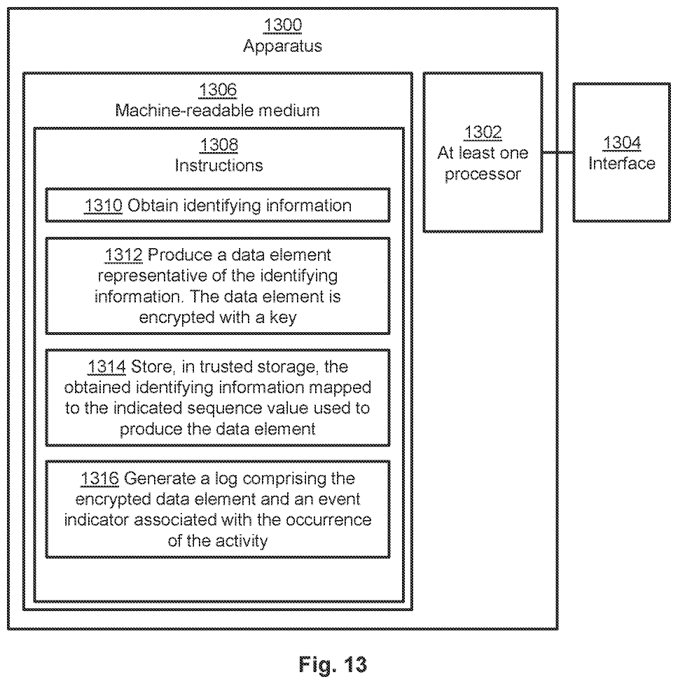

FIG. 13 is a schematic illustration of an example apparatus 1300 for implementing or at least partially facilitating certain methods or machine-readable media described herein (e.g., certain blocks of methods or certain instructions of machine-readable media implemented as part of the de-centralized scenario). The apparatus 1300 may therefore refer to the operation of the computing device 1204 of FIG. 12. However, other apparatus, methods and machine-readable media may implement the functionality of the other domains shown in FIG. 12. Thus, reference is made to FIG. 12 and other examples described herein with relevant functionality to the apparatus 1300.

The apparatus 1300 comprises at least one processor 1302 communicatively coupled to an interface 1304 (e.g., implemented by a communication interface of the apparatus 1300) for: receiving or accessing information such as identifying information (as may be obtained from the apparatus 1300 itself) and/or sequence values, and/or communicating with other entities in other domains.

In an example, the interface 1304 may receive information to be used by the apparatus 1300 when implementing certain methods or machine-readable media described herein. The apparatus 1300 further comprises a tangible machine-readable medium 1306 (e.g., ‘memory’) storing instructions 1308 readable and executable by the at least one processor 1302 to perform a method according to various examples described herein.

In this example, the at least one processor 1302 is communicatively coupled to the (secure) interface 1304 with the management domain 1222. The secure interface 1304 is to receive, from the management domain 1222: an indication of a sequence value generated by a sequence function that iterates the sequence value in response to a metric associated with activity of a computing network triggering iteration of the sequence value, where the computing network comprises the apparatus. The sequence value is associated with a lease indicating a time period over which the sequence value can be used. The secure interface 1304 is further to receive a key (e.g., from the key manager 1230).

The tangible machine-readable medium 1306 stores instructions 1308 readable and executable by the at least one processor 1302 to perform a method in a trusted execution environment 1250 of the at least one processor 1302.

The method implemented by the instructions 1308 comprises, at block 1310, obtaining identifying information associated with an occurrence of an activity within the computing network. The method further comprises, at block 1312, producing a data element representative of the identifying information by using the indicated sequence value as an input to a transformation function for at least partially concealing the identifying information when producing the data element. The data element may be encrypted using the key.

The method implemented by the instructions 1308 further comprises, at block 1314, storing, in trusted storage, the obtained identifying information mapped to the indicated sequence value used to produce the data element.

The method implemented by the instructions 1308 further comprises, at block 1316, generating a log comprising the encrypted data element and an event indicator associated with the occurrence of the activity.

Thus, similar to examples described in relation to the centralized scenario, the apparatus 1300 may output pseudonymized logs.

In some examples, the method implemented by the instructions 1308 may be implemented by the at least one processor 1302 alongside other methods described herein.

For example, the instructions 1308 may further comprise additional instructions readable and executable by the at least one processor 1302 to perform a method in the trusted execution environment 1250 such as described below.

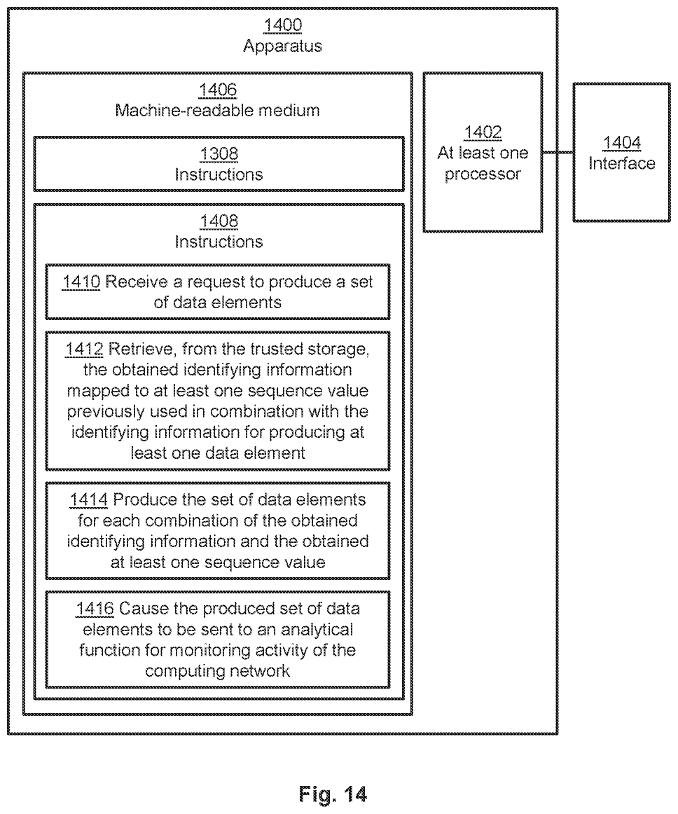

FIG. 14 is a schematic illustration of an example apparatus 1400 for implementing or at least partially facilitating certain methods or machine-readable media described herein (e.g., certain blocks of methods or certain instructions of machine-readable media implemented as part of the de-centralized scenario). The apparatus 1400 may therefore refer to the operation of the computing device 1204 of FIG. 12. However, other apparatus, methods and machine-readable media may implement the functionality of the other domains shown in FIG. 12. Thus, reference is made to FIG. 12 and other examples described herein with relevant functionality to the apparatus 1400.

The apparatus 1400 comprises at least one processor 1402 communicatively coupled to an interface 1404 (e.g., implemented by a communication interface of the apparatus 1400) for: receiving or accessing information such as identifying information (as may be obtained from the apparatus 1400 itself) and/or sequence values, and/or communicating with other entities in other domains. The apparatus 1400 has similar functionality to the apparatus 1300. In this regard, the apparatus 1400 comprises the instructions 1308 of FIG. 13 and further comprises additional instructions 1408 described below. The additional instructions 1408 may implement any method or combination of methods described herein.

In this example, the additional instructions 1408 implement a method comprising, at block 1410, receiving a request to produce a set of data elements, where the request is indicative of a time period of interest during which at least one sequence value was used as the input to the transformation function. The method further comprises, at block 1412, retrieving, from the trusted storage, the obtained identifying information mapped to at least one sequence value previously used in combination with the identifying information for producing at least one data element. The method further comprises, at block 1414, producing the set of data elements for each combination of the obtained identifying information and the obtained at least one sequence value by using each obtained sequence value as an input to the transformation function for at least partially concealing the identifying information when producing each data element of the set. The method further comprises, at block 1416, causing the produced set of data elements to be sent to an analytical function for monitoring activity of the computing network.

In some examples, any appropriate part of the examples relating to other methods and machine-readable media described herein may be provided as a method implemented by the instructions 1308 or 1408.

In addition, the apparatus 1300, 1400 refer to a method implemented by the computing device 1204 in FIG. 12. However, additional functionality is described in FIG. 12. For example, the management domain 1222, analytics domain 1224 and enterprise domain 1226 each have their own functionality implemented in the cloud or at another computing system e.g., managed by the enterprise function 1212. Thus, any of this functionality may be implemented by a method, machine-readable medium and/or apparatus as described herein. By way of example, at least some of the functionality of the management domain 1222 may be implemented by a method, machine-readable medium such as depicted by FIG. 9 or apparatus such as depicted by FIG. 13 or 14 (although in this case, the apparatus to implement the method or machine-readable is a different apparatus to the computing device 1204).

Accordingly, in some examples, a method, machine-readable medium and/or apparatus may comprise functionality associated with the trigger manager 1234 (e.g., including the storing of the sequence values 1232, if stored).

In some examples, a method, machine-readable medium and/or apparatus may comprise functionality associated with the key manager 1230 and/or registration function 1242 (e.g., for setting up a secure channel with the TEE 1250).

In some examples, a method, machine-readable medium and/or apparatus may comprise functionality associated with the re-identification function 1240.

Any combination of these examples may be implemented by a method, machine-readable medium and/or apparatus such as described elsewhere in this disclosure.

The examples described in relation to the de-centralized scenario may be combined in any appropriate way. For example, examples which relate to the centralized scenario may be combined with each other and with examples which relate to the de-centralized scenario. Similarly, concepts described in relation to the centralized scenario may be implemented in or used to modify concepts described in relation to the de-centralized scenario, and vice versa.

Any of the blocks, nodes, instructions or modules described in relation to the figures may be combined with, implement the functionality of or replace any of the blocks, nodes, instructions or modules described in relation to any other of the figures. For example, methods may be implemented as machine-readable media or apparatus, machine-readable media may be implemented as methods or apparatus, and apparatus may be implemented as machine-readable media or methods. Further, any of the functionality described in relation to any one of a method, machine readable medium or apparatus described herein may be implemented in any other one of the method, machine readable medium or apparatus described herein. Any claims written in single dependent form may be re-written, where appropriate, in multiple dependency form since the various examples described herein may be combined with each other.

Examples in the present disclosure can be provided as methods, systems or as a combination of machine-readable instructions and processing circuitry. Such machine-readable instructions may be included on a non-transitory machine (for example, computer) readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing circuitry, or a module thereof, may execute the machine-readable instructions. Thus, functional nodes, modules or apparatus of the system and other devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the scope of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
receiving:
identifying information associated with an occurrence of an activity within a computing network; and
an indication of a sequence value generated by a sequence function that iterates the sequence value in response to a metric associated with activity of the computing network triggering iteration of the sequence value; and
producing, using processing circuitry, a data element representative of the identifying information by using the indicated sequence value as an input to a transformation function for at least partially concealing the identifying information when producing the data element.

2. The method of claim 1, where the metric is obtained by an analytical function for monitoring the activity of the computing network.

3. The method of claim 1, comprising:
receiving:
an event indicator associated with the occurrence of the activity; and
the identifying information;
determining whether the identifying information has been previously used to produce the data element representative of the identifying information;
in response to determining that the identifying information has been previously used to produce the data element:
retrieving, from storage, the data element representative of the identifying information and generating a log comprising the event indicator and the retrieved data element, or
in response to determining that the identifying information has not been previously used to produce the data element:
causing the processing circuitry to produce the data element representative of the identifying information;
generating a log comprising the event indicator and the data element; and
causing the log to be sent to an analytical function for monitoring the activity of the computing network.

4. The method of claim 1, comprising
receiving a request to produce a set of data elements, where the request is indicative of a time period of interest during which at least one sequence value was used as the input to the transformation function;
in response to receiving the request, obtaining identifying information and/or the at least one sequence value used in the time period of interest;
producing the set of data elements for each combination of the obtained identifying information and the obtained at least one sequence value; and
causing the produced set of data elements to be sent to an analytical function for monitoring activity of the computing network.

5. The method of claim 4, where the analytical function is to use the produced set of data elements to analyze historical activity of the computing network associated with the identifying information.

6. The method of claim 4, comprising obtaining the identifying information and the at least one sequence value by:
where a mapping between the identifying information and at least one sequence value used to generate corresponding data elements representative of the identifying information is available, retrieving the identifying information and the at least one sequence value mapped to the identifying information, and/or
where the data element is produced by encrypting the identifying information; and
where the request comprises the data element and an authorization to decrypt and/or a key for decrypting the data element, decrypting the data element to retrieve the identifying information.

7. The method of claim 1, comprising: determining whether the metric meets a condition regulating how many data elements can be produced using the same sequence value such that:
where the condition is met, the sequence value remains the same; or
where the condition is not met, the sequence function iterates the sequence value unless an indication is received that prevents the sequence function from iterating the sequence value.

8. The method of claim 7, where the condition comprises a specified number of events occurring within the computing network or a specified time frame.

9. The method of claim 1, where the sequence function is to iterate the sequence value by progressing along a consecutive sequence or by implementing a random sequence value generator to generate an iterated sequence value.

10. The method of claim 1, further comprising generating a one-to-one mapping between the identifying information and the sequence value used to generate the data element representative of the identifying information.

11. The method of claim 10, where contextual information associated with the identifying information is used by the sequence function to produce a specified sequence of sequence values for use in producing data elements representative of identifying information associated with the contextual information, and where the generated mapping comprises a name indicator of the specified sequence.

12. The method of claim 1, comprising:
anonymizing a first portion of the identifying information relating to an identity of an individual entity within the computing network; and
producing the data element representative of a second portion of the identifying information comprising contextual information associated with the individual entity.

13. A tangible machine-readable medium comprising instructions which, when executed by at least one processor, cause the at least one processor to:
receive:
identifying information associated with an occurrence of an activity within a computing network;
an event indicator associated with the occurrence of the activity; and
an indication of a sequence value generated by a sequence function that iterates the sequence value in response to a metric associated with activity of the computing network triggering iteration of the sequence value, where the metric is obtained by an analytical function for monitoring the activity of the computing network;
produce a data element representative of the identifying information by using the indicated sequence value as an input to a transformation function for at least partially concealing the identifying information when producing the data element;
generate a log comprising the event indicator and the data element; and
cause the log to be sent to the analytical function.

14. Apparatus comprising:
at least one processor communicatively coupled to a secure interface with a management domain, where the secure interface is to receive, from the management domain:
an indication of a sequence value generated by a sequence function that iterates the sequence value in response to a metric associated with activity of a computing network triggering iteration of the sequence value, where the computing network comprises the apparatus, and where the sequence value is associated with a lease indicating a time period over which the sequence value can be used; and
a key; and
a tangible machine-readable medium storing instructions readable and executable by the at least one processor to perform a method in a trusted execution environment of the at least one processor, the method comprising:
obtaining identifying information associated with an occurrence of an activity within the computing network;
producing a data element representative of the identifying information by using the indicated sequence value as an input to a transformation function for at least partially concealing the identifying information when producing the data element, and where the data element is encrypted using the key;
storing, in trusted storage, the obtained identifying information mapped to the indicated sequence value used to produce the data element; and
generating a log comprising the encrypted data element and an event indicator associated with the occurrence of the activity.

15. The apparatus of claim 14, where the instructions further comprise instructions readable and executable by the at least one processor to perform a method in the trusted execution environment, the method comprising:
receiving a request to produce a set of data elements, where the request is indicative of a time period of interest during which at least one sequence value was used as the input to the transformation function;
retrieving, from the trusted storage, the obtained identifying information mapped to at least one sequence value previously used in combination with the identifying information for producing at least one data element;
producing the set of data elements for each combination of the obtained identifying information and the obtained at least one sequence value by using each obtained sequence value as an input to the transformation function for at least partially concealing the identifying information when producing each data element of the set; and
causing the produced set of data elements to be sent to an analytical function for monitoring activity of the computing network.
